(19) United States
(12) Patent Application Publication
(10) Pub. No.: US 2026/0285607 A1
(43) Pub. Date: Sep. 24, 2026

(54) APPARATUS FOR TRANSFERRING ARTICLES FROM A FIRST STATION TO A SECOND STATION

(71) Applicant: G.D S.p.A., Bologna (IT)

(72) Inventors: Daniele GROSSO, Bologna (IT); Luca TESTONI, Bologna (IT); Valerio AMORATI, Bologna (IT)

(21) Appl. No.: 19/478,372

(22) PCT Filed: Apr. 5, 2024
(86) PCT No.: PCT/IB2024/053334

§ 371 Date: Oct. 24, 2025

(30) Foreign Application Priority Data
Apr. 27, 2023 (IT) 102023000008256

(51) Int. Cl. B65G 25/04; B65G 47/52; B65G 47/90; B65G 54/02

(52) U.S. Cl. CPC B65G 25/04; B65G 47/52; B65G 47/90; B65G 54/02

(57) ABSTRACT

An apparatus for transferring articles from a first to a second station in a transfer direction includes: a first transfer device, having first and second gripping units arranged apart from one another in the transfer direction, the first gripping unit configured to pick up an article from the first station and bring it into a second intermediate position between the first and second stations, the second gripping unit configured to pick up the article in a first intermediate position between the first and second stations downstream of the second intermediate position, and release it in the second station; and a second transfer device, mobile between the first and second intermediate positions, and having a gripping unit for receiving the article from the first gripping unit in the second intermediate position, and for releasing it to the second gripping unit in the first intermediate position.

### TEXT OF THE DESCRIPTION

The present invention relates to an apparatus for transferring articles from a first station to a second station.

Incidentally, understood herein by “station” is any part of a machine provided for receiving articles and may, for example, be an operating station, in which the articles received undergo one or more operations, or else a waiting station, where the articles received are parked, waiting to be transferred to a further station, or else again a conveying station, where the articles received are handled to be sent on to a further station.

The first and second stations mentioned above may form part of two different machines or else of one and the same machine.

Known in the art are apparatuses for transferring articles that comprise gripping devices designed to pick up the articles and transfer them from a first station to a second station.

Transfer apparatuses according to the prior art may, for example, comprise handling devices of the pick & place type equipped with articulated robot arms.

Devices of this type are suitable for applications in which the two stations are set close to one another and where a relatively ample space for receiving the devices themselves is available.

In this context, the present invention presents a new apparatus for transferring articles from a first station to a second station, which affords a series of advantages as compared to the solutions of the prior art, as will emerge clearly from what follows.

In general, the present invention regards a transfer apparatus according to claim 1 and a transfer method according to claim 8.

The claims form an integral part of the teaching provided herein. Further characteristics and advantages of the present invention will emerge clearly from the ensuing description with reference to the annexed drawings, which are provided purely by way of non-limiting example and in which:

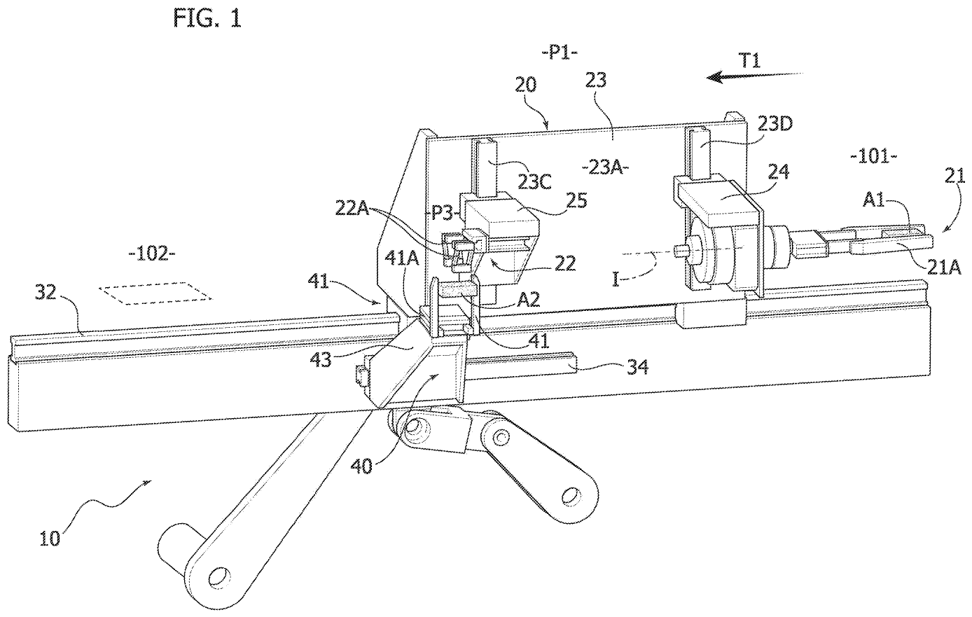

FIG. 1 illustrates an example of the apparatus described herein in a first operating step;

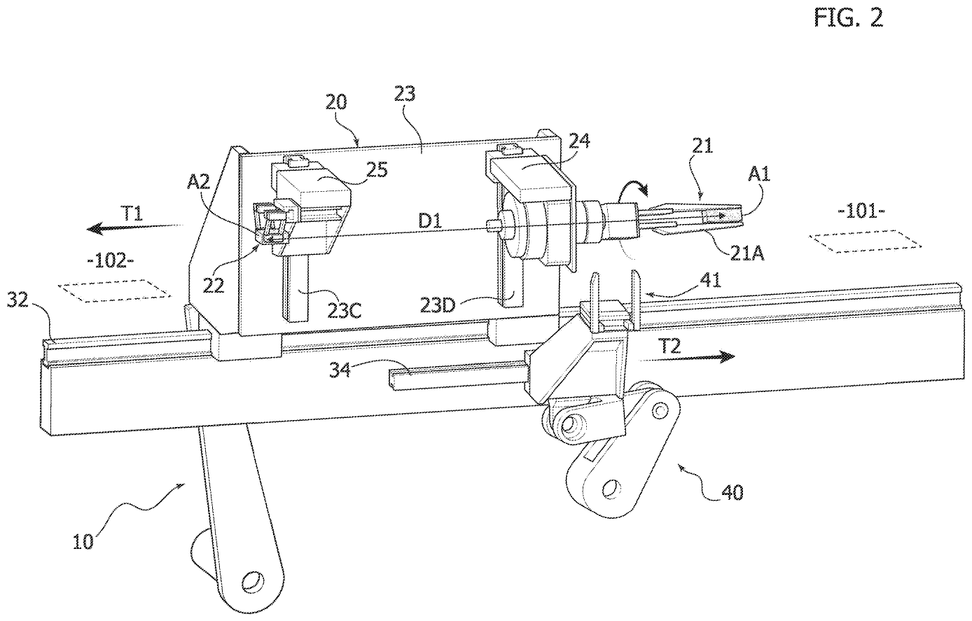

FIG. 2 illustrates the apparatus of FIG. 1 in a second operating step;

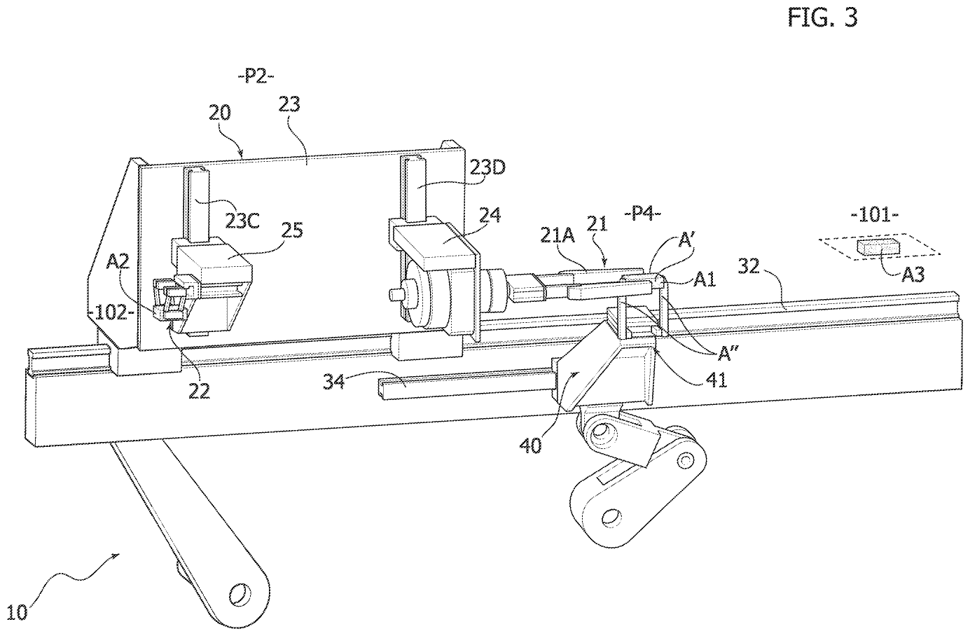

FIG. 3 illustrates the apparatus of FIG. 1 in a third operating step; and

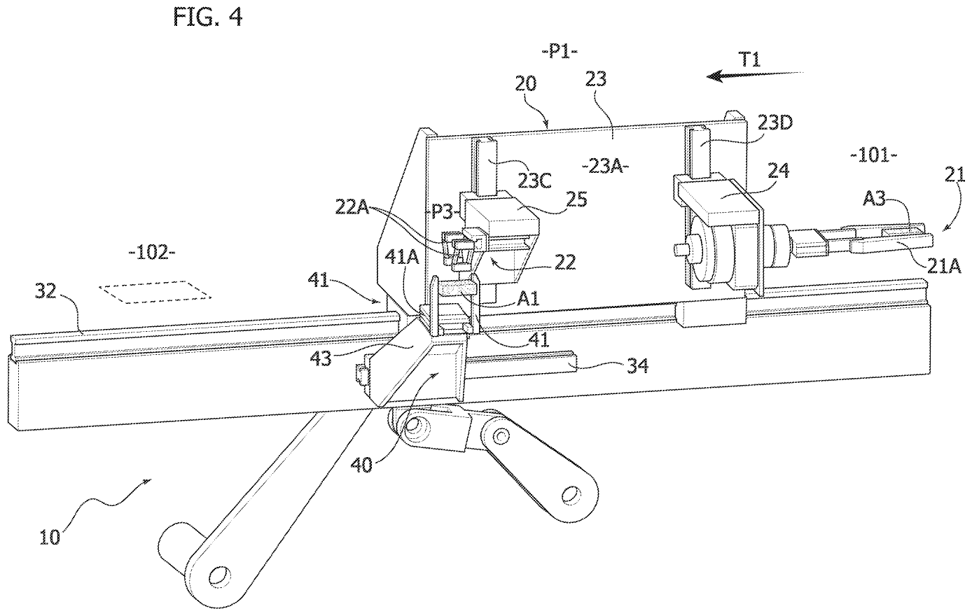

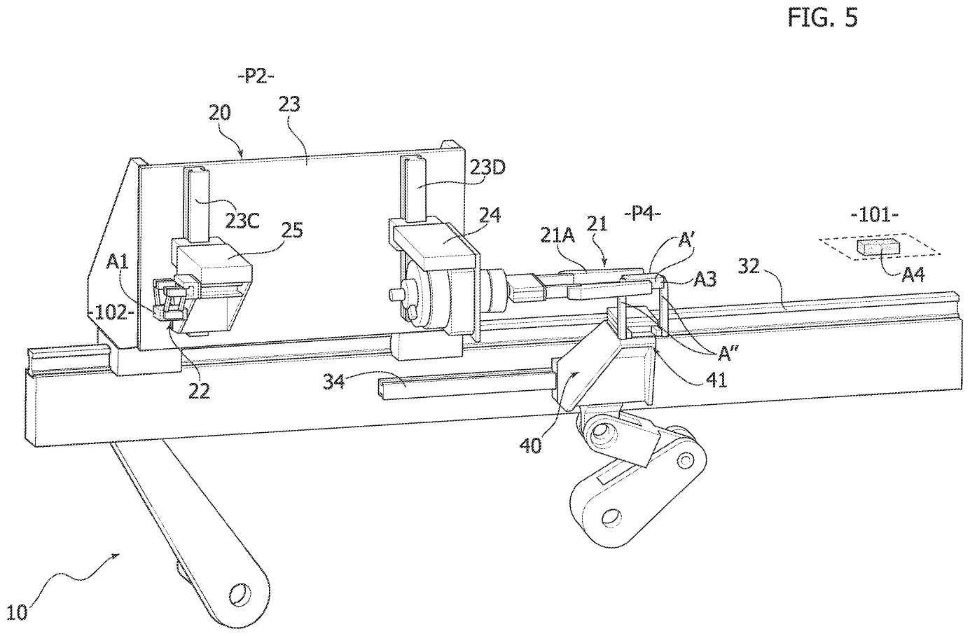

FIGS. 4 and 5 illustrate operating steps of the apparatus of FIG. 1 subsequent to the step illustrated in FIG. 3.

In the ensuing description, various specific details are illustrated aimed at enabling an in-depth understanding of the embodiments. The embodiments may be obtained without one or more of the specific details, or with other methods, components, or materials, etc. In other cases, known structures, materials, or operations are not illustrated or described in detail so that various aspects of the embodiment will not be obscured.

The references used herein are provided merely for convenience and hence do not define the sphere of protection or the scope of the embodiments.

As anticipated above, the apparatus described herein operates for transferring articles from a first station to a second station. The context of application of the apparatus described herein may regard any technical field, whether this be the production field or the packaging or logistics fields, etc. Likewise, the apparatus can operate on articles of any kind, for example articles of the tobacco industry, articles of the pharmaceutical sector, toys, etc.

Moreover, as already mentioned above, understood herein by “station” is any part of a machine provided for receiving articles, and may, for example, be an operating station in which the articles received undergo one or more operations, or else a waiting station, where the articles received are parked, waiting to be transferred to a further station, or else again a conveying station, where the articles received are handled to be sent on to a further station.

With reference to the figures, the apparatus described herein, designated as a whole by the reference number 10, comprises a first transfer device 20 and a second transfer device 40, which are provided for co-operating with one another to transfer articles A (in the figures, also designated individually by A1, A2, A3, etc.) from a first station 101 to a second station 102.

The two transfer devices 20, 40 are both mobile in a transfer direction T that connects the first station 101 to the second station 102.

In the example illustrated, the transfer direction T is rectilinear; in alternative embodiments, the transfer direction T could, instead, follow paths of a different type, for example curvilinear or else composite paths, formed by at least one rectilinear stretch and at least one curvilinear stretch.

In one or more preferred embodiments, like the one illustrated, the apparatus 10 comprises a rectilinear guide 32, which extends in the transfer direction T and slidably mounted on which is the transfer device 20, and a second rectilinear guide 34, which itself also extends in the transfer direction T and slidably mounted on which is the transfer device 40.

In one or more preferred embodiments, like the one illustrated, the transfer device 20 comprises a first gripping unit 21 and a second gripping unit 22, arranged at a distance from one another in the transfer direction T.

Incidentally, it is pointed out that in what follows reference will always be made to picking-up of a single article by the gripping units of the apparatus 10; however, the aforesaid gripping units may also be operated to pick up, each, a number of articles at a time, according to the requirements of the specific applications.

In particular, in one or more preferred embodiments, like the one illustrated, the transfer device 20 comprises a mobile support 23, which is slidably mounted on the rectilinear guide 32, for example via interposition of one or more sliding blocks, and on which the two gripping units 21 and 22 are in turn mounted at a pre-set distance apart D1 in the transfer direction T (in FIG. 1 this distance is defined with reference to the point of each of the two gripping units in which the centre of the article is located when the latter is received therein). The support 23 is driven in its movement on the guide 32 by way of a driving system of a conventional type.

In one or more preferred embodiments, like the one illustrated, the mobile support 23 comprises a substantially vertical wall 23A, which is contained in a vertical plane parallel to the transfer direction T and on which the two gripping units 21, 22 are mounted.

In one or more preferred embodiments, like the one illustrated, the two gripping units 21, 22 are mounted on the support 23 so as to be vertically mobile, preferably in a synchronized way, between a lowered position and a raised position. In particular, in one or more preferred embodiments, like the one illustrated, fixed on the vertical wall 23A of the support 23 is a first vertical rectilinear guide 23D, slidably mounted on which (for example, by way of a sliding block) is a bracket 24 that carries the gripping unit 21, and a further vertical rectilinear guide 23C parallel to the guide 23D, slidably mounted on which (for example, via interposition of a sliding block) is a bracket 25 that carries the gripping unit 22.

In one or more preferred embodiments, the apparatus 10 comprises respective actuators (not illustrated), preferably of a linear type, for driving vertical movement of the two gripping units 21, 22. In alternative embodiments, the apparatus may, instead, comprise a single actuator provided for driving vertical movement of both of the two gripping units. In this case, the mobile brackets 24, 25 may, for example, be connected by a mobile connection structure.

The second transfer device 40 itself also comprises a mobile support 43, slidably mounted on the guide 34, and a gripping unit 41, mounted on the mobile support 43, preferably in a fixed position. The support 43 is driven in its movement on the guide 34 by way of a driving system of a conventional type.

In one or more preferred embodiments, like the one illustrated, each of the gripping units 21, 22, and 41 comprises a respective end effector, 21A, 22A, 41A, provided for gripping the articles A. Preferably, each end effector is equipped with a pair of gripping members provided for gripping between them the articles A, and may, for example, be of a pincer or vice type, or of other equivalent types.

For reasons that will emerge clearly in what follows, in one or more preferred embodiments, like the one illustrated, the two gripping units 21, 22 of the transfer device 20 are each prearranged for engaging a first pair of opposite sides A′ of the article A, whereas the gripping unit 41 of the transfer device 40 is provided for engaging a different pair of opposite sides A″ of the article A.

With reference now to operation of the apparatus 10, the transfer device 20 is mobile in the transfer direction T between a picking-up position P1 (illustrated in FIG. 1) and a releasing position P2 (illustrated in FIG. 3).

When the transfer device 20 is in the picking-up position P1, the gripping unit 21 is located in the first station 101 to pick up an article A1 from the station itself. At the same time, the gripping unit 22 is located in an intermediate position P3 between the station 101 and the station 102, to pick up a second article A2 from the gripping unit 41 of the transfer device 40 in the same position; the second article A2 is an article picked up from the station 101 by the device 20 itself before the article A1 and brought into the intermediate position P3 as a result of the combined action of the devices 20 and 40, as will be seen hereinafter.

When the transfer device 20 is in the releasing position P2, the gripping unit 22 is located in the station 102 to release the second article A2 to the same station, while the gripping unit 21 is located in a, further, intermediate position P4 between the station 101 and the station 102, which is closer to the station 101 than is the intermediate position P3, to release the article A1 to the gripping unit 41 of the transfer device 40 in the same intermediate position P4.

The gripping units 21, 22 are in their raised position when the transfer device 20 moves between the two positions P1 and P2, and are instead brought into their lowered position to pick up the articles or else to release them in the way described above.

On the other hand, as emerges from the foregoing, the transfer device 40 is mobile between the two intermediate positions P3 and P4; in the intermediate position P4, its gripping unit 41 receives the article A (A1 or A2) from the gripping unit 21 of the transfer device 20 in the releasing position P2, whereas, in the intermediate position P3, the gripping unit 41 releases the same article to the gripping unit 22 of the transfer device 20 in the picking-up position P1.

It may be noted that the two transfer devices 20, 40 both move according to a reciprocating motion in the transfer direction T, between the positions P1 and P2 and the positions P3 and P4, respectively, but in an asynchronous way such that, when the transfer device 20 shifts to the left (as viewed in the figures) from the position P1 to the position P2, the transfer device 40 shifts to the right from the position P3 to the position P4, and vice versa. In this connection, FIG. 2 illustrates a step of the apparatus 10 in which the transfer device 20 is moving in the direction T1 to reach the position P2 from the position P1, while the transfer device 40 is moving in the opposite direction T, to reach the position P4 from the position P3.

In the intermediate positions P4, P3, the single article has passed from the gripping unit 21 to the gripping unit 41 and thence to the gripping unit 22, respectively, without ever being released to other supporting means and being, instead, always supported by at least one of the gripping units 21, 22, and 41. It may now be understood that the fact that the two gripping units 21, 22, on the one hand, and the gripping unit 41, on the other, are designed for engaging the two different pairs of opposite sides A′, A″ will facilitate passage of the article from one unit to another without any risk of interference between them.

In view of the foregoing, the transfer device 20 operates both to pick up each article from the station 101, by means of its gripping unit 21, and to bring the same article to the station 102, by means of its gripping unit 22.

Passage of the article from the gripping unit 21 to the gripping unit 22 occurs through the movement of return of the transfer device 20 from the releasing position to the picking-up position and as a result of the co-operation of the transfer device 40. In fact, the transfer device 40 temporarily takes upon itself the article, which it receives from the gripping unit 21, and subsequently returns it to the gripping unit 22, when the transfer device 20 is brought back into the picking-up position.

In this position, in the meantime the transfer device 20 picks up a new article from the station 101 via the gripping unit 21, which it then releases to the transfer device 40, when the gripping unit 22 finally delivers the previous article to the station 102.

On the other hand, the transfer device 40 does not limit itself to withholding the article, waiting for it to be picked up again by the transfer device 20, but also takes the article from the intermediate position P4 to the intermediate position P3, thus enabling the conveying device 20 to perform a movement, in the transfer direction T, that is more limited than in the case where the gripping unit 41 were, instead, fixed and not mobile.

In fact, in the case of the solution described herein, the conveying device 20 merely has to move the gripping unit 21 between the station 101 and the intermediate position P4 and the gripping unit 22 between the intermediate position P3 and the station 102; in the other case, instead, the device 20 would have had to move the two gripping units 21, 22, respectively, between the stations 101 and 102 and one and the same intermediate position that is certainly more distant from the two stations than are the intermediate positions P3 and P4.

The person skilled in the sector will understand that the two intermediate positions P3 and P4 are determined by the pre-set distance D1 between the gripping unit 21 and the gripping unit 22 of the transfer device 20.

In general, with reference to FIGS. 1 to 3, operation of the apparatus described herein hence envisages the following steps:
bringing the transfer device 20 into the picking-up position P1;
bringing the transfer device 40 into the intermediate position P3;
via the gripping unit 21, picking up a first article A1 from the first station 101;
via the gripping unit 22, picking up a second article A2 from the gripping unit 41 of the transfer device 40 in the intermediate position P3;
bringing the transfer device 20 into the releasing position P2;
bringing the transfer device 40 into the intermediate position P4;
via the gripping unit 21, releasing the first article A1 to the gripping unit 41 of the transfer device 40 in the intermediate position P4; and
via the gripping unit 22, releasing the second article A2 to the second station 102.

Then, with reference to FIGS. 4 and 5, operation of the apparatus described herein may envisage the following steps:
bringing the transfer device 20 into the picking-up position P1;
bringing the transfer device 40 into the intermediate position P3;
via the gripping unit 21, picking up a third article A3 from the first station 101;
via the gripping unit 22, picking up the first article A1 from the gripping unit 41 of the transfer device 40 in the intermediate position P3;
bringing the transfer device 20 into the releasing position P2;
bringing the transfer device 40 into the intermediate position P4;
via the gripping unit 21, releasing the third article A3 to the gripping unit 41 of the transfer device 40 in the intermediate position P4; and
via the gripping unit 22, releasing the first article A1 to the second station 102.

It may now be noted that, as compared to the transfer devices according to the prior art mentioned at the outset, the apparatus described herein has a very simple and fairly compact structure, operation of which is based upon movements of the gripping units exclusively along linear axes that enable the apparatus to operate at very high rates.

In one or more preferred embodiments, like the one illustrated, the gripping unit 21 is rotatable about an axis of rotation I to modify orientation of the article that it has picked up, before releasing it to the gripping unit 41 of the transfer device 40. For this purpose, the gripping unit 21 is rotatably mounted on the bracket 25 via interposition of a bearing member (not illustrated) and is operatively connected to an actuator (not illustrated), for example a rotary electric motor, provided for driving the movement of rotation of the gripping unit 21 itself. In an alternative embodiment (not illustrated) it may, instead, be the gripping unit 22 that is pre-arranged for performing the aforesaid movement of rotation.

In a further embodiment (not illustrated), the gripping unit 41 may be rotatable about an axis of rotation to modify orientation of the article picked up, in a way similar to what has been described with reference to the gripping unit 21.

In a preferred application of the apparatus described herein, the first station and/or the second station each are/is a conveyor, preferably a conveyor of a linear-electric-motor type. In this case, the gripping unit 21 is designed to pick up each article from a respective carriage of the conveyor that defines the station 101, whereas the gripping unit 22 is provided for releasing each article onto a respective carriage of the conveyor that defines the station 102.

In a further application, it is possible to envisage a plurality of apparatuses of the type described herein arranged in series in the transfer direction T in such a way that, for each apparatus set in an intermediate position of the series, the related stations 101 and 102 correspond, respectively, to the station 102 of the adjacent apparatus set upstream and to the station 101 of the adjacent apparatus set downstream, and, likewise, for the first apparatus of the series, the station 102 corresponds to the station 101 of the second apparatus of the series, and, for the last apparatus of the series, the station 101 corresponds to the station 102 of the penultimate apparatus. In this case, in the stations 101 and 102 the articles can be directly exchanged between the gripping units of the different apparatuses, without there hence being any need to provide other means for supporting the articles in the aforesaid stations. On the other hand, in such an application, the various apparatuses may envisage a common rectilinear guide 32 that traverses the entire series of apparatuses, from the station 101 of the first apparatus to the station 102 of the last apparatus.

Of course, without prejudice to the principle of the invention, the details of construction and the embodiments may vary, even significantly, with respect to what has been illustrated herein purely by way of non-limiting example, without thereby departing from the scope of the invention, as defined by the annexed claims.

1. An apparatus for transferring articles from a first station to a second station in a transfer direction, comprising:
a first transfer device, comprising a first gripping unit and a second gripping unit arranged at a distance from one another in the transfer direction, with the first gripping unit configured to pick up an article from said first station and bring the article into a second intermediate position between said first station and said second station, and with the second gripping unit configured to pick up the article in a first intermediate position between said first station and said second station, downstream of the second intermediate position in the transfer direction, and release the article in said second station; and
a second transfer device, which is mobile between said first intermediate position and said second intermediate position and comprises a third gripping unit provided for receiving said article from said first gripping unit of said first transfer device, in said second intermediate position, and for releasing said article to said second gripping unit of said first transfer device, in said first intermediate position.

2. The apparatus according to claim 1, wherein said first transfer device is mobile in said transfer direction between a picking-up position and a releasing position, and
wherein said first gripping unit and said second gripping unit are arranged at a distance from one another in the transfer direction in such a way that, when said first transfer device is in said picking-up position, said first gripping unit is located in said first station to pick up the article from said first station, while said second gripping unit is located in said first intermediate position (P3) to pick up a second article from said third gripping unit of said second transfer device, and when said first transfer device is located in said releasing position, said second gripping unit is located in said second station to release said second article to said second station, while said first gripping unit is located in said second intermediate position to release said article to the third gripping unit of said second transfer device.

3. The apparatus according to claim 1, wherein said first transfer device comprises a support, which is mobile on a rectilinear guide that extends in said transfer direction and on which said first and second gripping units are mounted for being vertically mobile in a way fixed with respect to one another, between a lowered position for picking up the article from the first station or from the gripping unit of the second transfer device or for releasing the article to the second station or to the gripping unit of the second transfer device and a raised position for moving the first transfer device between said picking-up position and said releasing position.

4. The apparatus according to claim 1, wherein said second transfer device is itself also mobile in said transfer direction.

5. The apparatus according to claim 1, wherein said second transfer device comprises a support, which is mobile on a rectilinear guide that extends in said transfer direction and on which said gripping unit is mounted in a fixed position.

6. The apparatus according to claim 1, wherein said first gripping unit and/or said second gripping unit of said first transfer device each are/is provided for engaging a first pair of opposite sides of said article, and wherein said gripping unit of said second transfer device is provided for engaging a second pair of opposite sides of said article different from said first pair of opposite sides.

7. The apparatus according to claim 1, wherein said first gripping unit or said second gripping unit of said first transfer device is rotatable about an axis of rotation to modify an orientation of the article picked up by said third gripping unit or said second gripping unit.

8. A method for transferring articles from a first station to a second station via a transfer apparatus according to claim 1, comprising the steps of:
bringing said first transfer device into a picking-up position;
bringing said second transfer device into said first intermediate position;
via said first gripping unit, picking up the article from said first station;
via said second gripping unit, picking up a second article from said third gripping unit of said second transfer device in said first intermediate position;
bringing said first transfer device into a releasing position;
bringing said second transfer device into said second intermediate position;
via said first gripping unit, releasing said article to said gripping unit of said second transfer device in said second intermediate position; and
via said second gripping unit, releasing said second article in said second station.

9. The method according to claim 8, further comprising the steps of:
bringing said first transfer device into said picking-up position;
bringing said second transfer device into said first intermediate position;
via said first gripping unit, picking up a third article from said first station;
via said second gripping unit, picking up said first-article from said gripping unit of said second transfer device in said first intermediate position;
bringing said first transfer device into said releasing position;
bringing said second transfer device into said second intermediate position;
via said first gripping unit, releasing said third article to said third gripping unit of said second transfer device in said second intermediate position; and
via said second gripping unit, releasing said article in said second station.

10. The method according to claim 8, wherein said first station is a conveyor, including a conveyor of a linear-electric-motor type, and wherein
said step of picking up said article in said first station includes picking up said article from a mobile carriage of said conveyor.

11. The method according to claim 8, wherein said second station is a conveyor, including a conveyor of a linear-electric-motor type, and wherein said step of releasing said second article to said second station includes releasing said second article onto a carriage of said conveyor.

12. The method according to claim 9, wherein said second station is a conveyor, including a conveyor of a linear-electric-motor type, and wherein said step of releasing said article to said second station includes releasing said article onto a carriage of said conveyor.

13. The method according to claim 9, wherein said first station is a conveyor, including a conveyor of a linear-electric-motor type, and wherein said step of picking up said third article in said first station includes picking up said third article from a mobile carriage of said conveyor.
